(19) United States
(12) Patent Application Publication
(10) Pub. No.: US 2007/0162733 A1
(43) Pub. Date: Jul. 12, 2007

(54) Secure CMOS

(75) Inventors: Lowell B. Dennis, Pflugerville, TX (US); James E. Dailey, Round Rock, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/326,698

(22) Filed: Jan. 6, 2006

(51) Int. Cl. G06F 15/177

(52) U.S. Cl. 713/1

(57) ABSTRACT

For changing configuration data (CFD) stored in a non-volatile memory (NVM) device of an information handling system (IHS), a determination is made whether the IHS is operating in a startup mode or in a run-time mode. In the startup mode, a basic input output system (BIOS) program stored in the NVM is executed to change the CFD. In the run-time mode, an application program (AP) is executed to interface with the BIOS for changing the CD. The AP provides an authentication request to enable the AP to change the CFD and the BIOS provides a security access key to the AP in response to authenticating the request. The CFD is received and changed by the AP to generate a revised CFD. The revised CFD and the security access key are provided to the BIOS to save the change in the NVM.

### BACKGROUND

The present disclosure relates generally to memory devices, and more particularly to tools and techniques for enhancing security of configuration data stored in memory devices of an information handling system.

As the value and use of information continues to increase, individuals and businesses seek additional ways to acquire, process and store information. One option available to users is information handling systems. An information handling system (‘IHS’) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, entertainment, and/or global communications. In addition, information handling systems may include a variety of hardware and software components that may be configured to process, store, and communicate information and may include one or more computer systems, data storage systems, and networking systems.

A basic input/output system (BIOS) is generally a memory resident software program which includes instructions required to control computer peripherals such as the keyboard, display screen, disk drives, serial communications, and other functions without relying on a hard disk. The BIOS may be referred to as ‘firmware’ since it is typically stored in a non-volatile memory (NVM), e.g., flash memory. This ensures that the BIOS will be available to boot the system, even when there is a disk failure.

The BIOS also typically includes a SETUP code and a power-on-self-test (POST) program, both of which are well known to those skilled in the art. The SETUP code lets a user configure the computer system in a desired manner, e.g., by specifying whether certain features are enabled or disabled, and by specifying certain preferences. Computer system configuration generally refers to a process for setting, defining, and/or selecting hardware, software properties, parameters, or attributes of the system. The POST code tests and initializes various components, when the system is activated. Both the SETUP and POST codes are typically stored in non-volatile memory (NVM).

Presently, a computer system configuration is stored in a battery backed CMOS memory device. Since the configuration data stored in the CMOS memory is susceptible to being inadvertently and/or maliciously changed, a well known technique to provide improved security for configuration data is to use a NVM device such as flash memory.

However, implementing a change in the system configuration is possible only by executing the SETUP code, which is executed during a startup mode of the computer system (e.g., before loading an operating system (OS) of the computer). It may be desirable to implement a change in the system configuration not only during the startup mode, but also during run-time mode (e.g., after loading the OS and the computer system is operable to execute application software programs). Additionally, it may be desirable to provide improved security and/or authentication mechanisms to avoid inadvertent and/or malicious changes made to the system configuration data during run-time.

Therefore, a need exists to provide for changing system configuration data of an information handling system. Accordingly, it would be desirable to provide for implementing secured changes to the system configuration data of an information handling system during startup and/or run-time, absent the disadvantages found in the prior methods discussed above.

### SUMMARY

The foregoing need is addressed by the teachings of the present disclosure, which relates to a system and method for securely changing configuration data of an information handling system (IHS). Accordingly, one embodiment provides for changing configuration data stored in a non-volatile memory (NVM) device of an information handling system (IHS). A determination is made whether the IHS is operating in a startup mode or in a run-time mode. In the startup mode, a basic input output system (BIOS) stored in the NVM is executed to change the configuration data. In the run-time mode, an application program (AP) is executed to interface with the BIOS for changing the configuration data.

### BRIEF DESCRIPTION OF THE DRAWINGS

FIG. 1 illustrates a block diagram of an information handling system 100 having a basic input output (BIOS) program and an application program to change configuration data, according to an embodiment.

FIG. 2A is a flow chart illustrating a method for securely changing configuration data during a startup mode, according to an embodiment.

FIG. 2B is a flow chart illustrating a method for securely changing configuration data by executing a SETUP code, according to an alternative embodiment.

FIG. 2C is a flow chart illustrating a method for securely changing configuration data during run-time by executing an application program that interacts with a BIOS run-time code, according to an embodiment.

### DETAILED DESCRIPTION

Novel features believed characteristic of the present disclosure are set forth in the appended claims. The disclosure itself, however, as well as a preferred mode of use, various objectives and advantages thereof, will best be understood by reference to the following detailed description of an illustrative embodiment when read in conjunction with the accompanying drawings. The functionality of various circuits, devices, boards, cards, modules, blocks, and/or components described herein may be implemented as hardware (including discrete components, integrated circuits and systems-on-a-chip ‘SOC’), firmware (including application specific integrated circuits and programmable chips) and/or software or a combination thereof, depending on the application requirements.

Configuration data stored in a battery backed CMOS memory device is susceptible to being inadvertently and/or maliciously changed. A well known technique to provide improved security for configuration data is to use a NVM device such as flash memory. However, implementing a change in the system configuration is possible only by executing the SETUP code, which is executed during a startup mode of the computer system (e.g., before loading an operating system (OS) of the computer). It may be desirable to implement a change in the system configuration not only during the startup mode, but also during run-time mode (e.g., after loading the OS and the computer system is operable to execute application software programs). Thus, a need exists to provide an improved method and system for changing configuration data.

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the IHS may be a personal computer, including notebook computers, personal digital assistants, cellular phones, gaming consoles, a network storage device, or any other suitable device and may vary in size, shape, performance, functionality, and price. The information handling system may include random access memory (RAM), one or more processing resources such as central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to receive/transmit communications between the various hardware components.

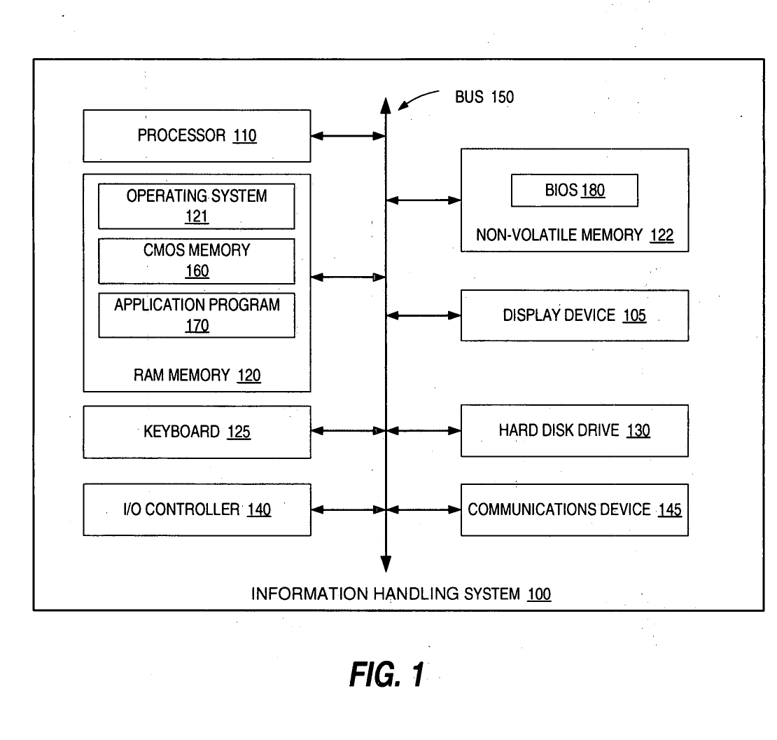

FIG. 1 illustrates a block diagram of an information handling system 100 having a basic input output (BIOS) and an application program to change configuration data, according to an embodiment. The information handling system 100 includes a processor 110, a random access memory (RAM) 120 (also referred to as main memory), a non-volatile memory NVM 122, a display device 105, a keyboard 125 and an I/O controller 140 for controlling various other input/output devices. For example, the I/O controller 140 may include a keyboard controller, a cursor device controller and/or the serial I/O controller. It should be understood that the term “information handling system” is intended to encompass any device having a processor that executes instructions from a memory medium.

In a particular embodiment, a portion of the RAM 120 is a battery backed CMOS memory device 160. The CMOS memory device 160 is used to store IHS configuration data such as hard disk settings, devices and input/output (I/O) ports, date and time settings, system security settings, start options, power management settings and similar others. In a particular embodiment, another portion of the RAM 120 is used to store an application program 170. The application program 170 includes one or more instructions that are executable by the processor 110 to change configuration data during a run-time of the IHS 100.

In a particular embodiment, a portion of the NVM 122 is used to stored a basic input output system (BIOS) 180 and another portion (not shown) of the NVM 122 is used to store the configuration data, which is substantially consistent with the configuration data stored in the battery backed CMOS memory device 160.

The processor 110 communicates with the system components via a bus 150, which includes data, address and control lines. In one embodiment, the IHS 100 may include multiple instances of the bus 150. A communications device 145, such as a network interface card and/or a radio device, may be connected to the bus 150 to enable wired and/or wireless information exchange between the IHS 100 and other devices/systems (not shown) such as another IHS (AIHS).

The processor 110 is operable to execute the computing instructions and/or operations of the IHS 100. The memory medium, e.g., RAM 120, preferably stores instructions (also known as a “software program”) for implementing various embodiments of a method in accordance with the present disclosure. An operating system (OS) 121 of the IHS 100 is a type of software program that controls execution of other software programs, referred to as the application software programs. In various embodiments the instructions and/or software programs may be implemented in various ways, including procedure-based techniques, component-based techniques, and/or object-oriented techniques, among others. The BIOS 180 is typically programmed in an assembly language. Software may also be implemented using C, XML, C++ objects, Java and Microsoft's .NET technology.

In a non-depicted, exemplary embodiment, the IHS 100 is operable in a plurality of operating modes such as a startup mode, an idle mode, a run-time mode, a safe mode and similar others. The IHS 100 may be described to be operating in a startup (or boot up) mode when executing BIOS code such as the SETUP and POST codes. The IHS 100 may exit the startup mode when the POST code execution is complete and control is transferred from the BIOS 180 to the operating system (OS) 121 of the IHS 100. The IHS 100 may be described to be operating in a run-time mode when the OS is loaded and is operable to execute one or more application programs such as the application program 170.

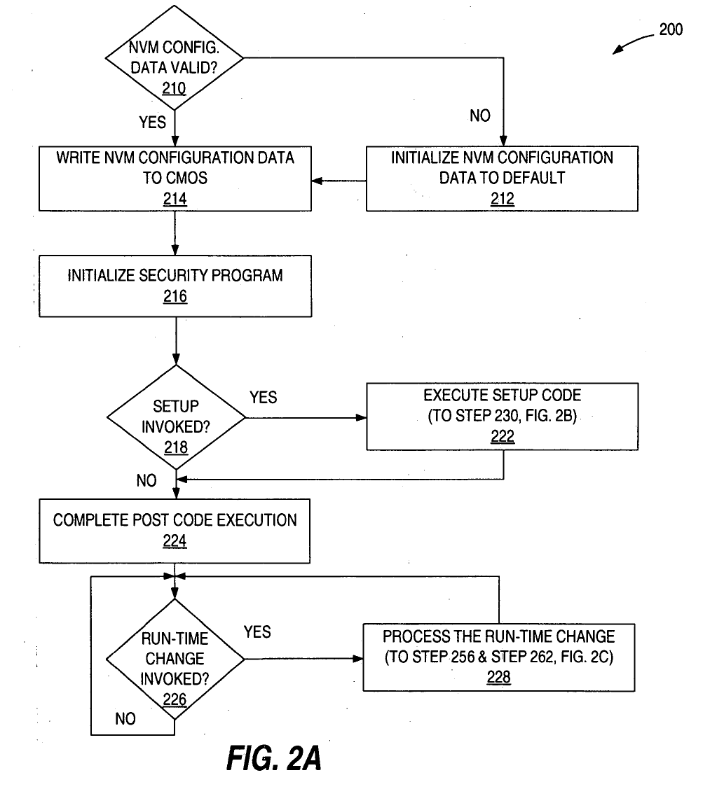

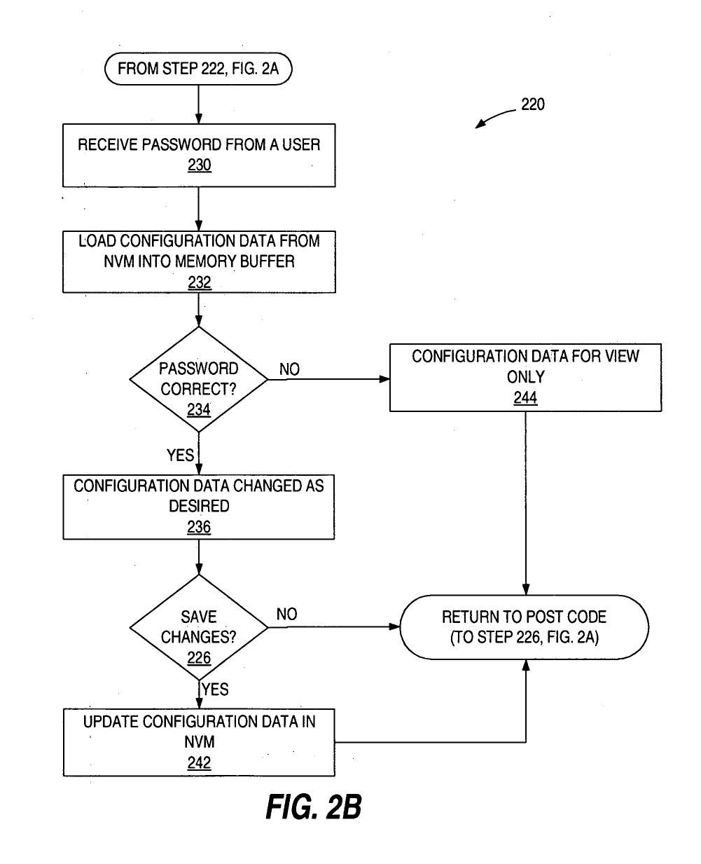

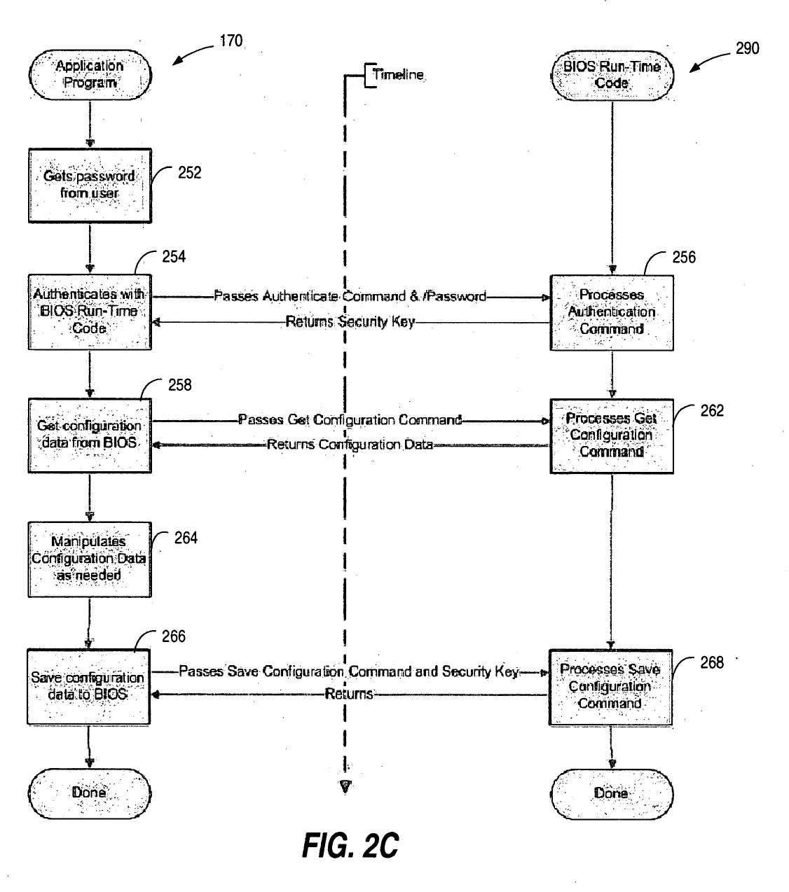

In a particular embodiment, changes to the configuration data is performed by automatically selecting one or more programs for execution, based on an operating state of the IHS 100. Additional details of securely changing the configuration data during a startup mode is illustrated with reference to FIGS. 2A and 2B and changing the configuration data during a run-time mode is illustrated with reference to FIG. 2C.

FIG. 2A is a flow chart illustrating a method for securely changing configuration data during a startup mode, according to an embodiment. In a particular embodiment, a basic input output system (BIOS) includes a power-on-self-test (POST) code 200, which is executed after initial power-on and/or reset of the IHS 100. In a particular embodiment, the POST code 200 includes instructions to automatically selecting one or more programs for changing the configuration data based on an operating state of the IHS 100.

In step 210, a determination is made whether the configuration data stored in the NVM, e.g., the NVM 122, is valid by performing one or more tests such as a checksum and/or a CRC check. In step 212, in response to determining that the configuration data is invalid, the NVM is initialized thereby initializing configuration data to a factory setting and/or a default level. In step 214, in response to determining that the configuration data is valid or after step 212, the configuration data from NVM is written to a CMOS device, e.g., the CMOS memory device 160. In step 216, a security program/protocol included in the BIOS 180 is initialized. In a particular embodiment, security program includes instructions to authenticate users and a check for authorization to make configuration changes. In step 218, a determination is made whether a request to execute a SETUP code is received. In step 222, the SETUP code is executed. Additional detail of the SETUP code to setup and/or configure IHS 100 system attributes, properties and/or parameters is described with reference to FIG. 2B.

In step 224, in response to determining that a request to execute the SETUP code is not received a remaining portion of the POST code is executed. Executing the remaining portion of the POST code may include loading the OS of the IHS 100. Completion of the POST code is indicative of a transition from a startup mode of operation to a run-time mode of operation of the IHS 100. In step 226, a determination is made by a run-time portion of the BIOS 180 (referred to as a BIOS run-time code) whether a request for making a run-time change has been invoked. If no run-time change request is detected, the BIOS run-time code loops on itself, awaiting invocation by an application program, e.g., the application program 170. In step 228, the BIOS run-time code determines that a run-time change is invoked and proceeds to process the change request. After processing the change, the BIOS run-time code checks for the run-time change. Additional detail of the application program 170 interfacing with a BIOS run-time code to change configuration data is described with reference to FIG. 2C.

FIG. 2B is a flow chart illustrating a method for securely changing configuration data by executing a SETUP code 220, according to an embodiment. As described earlier with reference to step 222, the SETUP code 220 is executed in response to determining that a request to execute the SETUP code is received. In a particular embodiment, the SETUP code is executed to implement the method for securely changing configuration data stored in a non-volatile memory (NVM) during a startup mode. To request a change in the configuration data a user may activate a predefined key such as F2, F1, ESC, DEL or similar other, immediately after initial power on or reset to execute the SETUP code.

In step 230, a password is received from the user to establish authenticity and verify authorization to make a change in the configuration data. In an embodiment, the password may use encryption/decryption technology for improved security. In step 232, the configuration data stored in the NVM is loaded into a read/write enabled memory buffer. In step 234, a determination is made whether the password provided by the user is authentic and the user is authorized to make a change to the configuration data. In step 236, in response to authenticating the user and the authority to make a change, the user is enabled to manipulate the configuration data stored in the memory buffer to make one or more changes. In step 238, a determination is made whether the one or more changes to the configuration data are to be saved in the NVM by requesting a confirmation from the user. In step 242, in response to receiving a confirmation from the user to save the changes to the configuration data the memory buffer is saved as revised configuration into the NVM. In step 244, in response to determining that the password failed authentication and/or authorization check, the user may be enabled to view the configuration data but not change the configuration data and program control is returned to step 224 described with reference to FIG. 2A. In response to determining that the user does not desire to save the changes to the configuration data or after updating configuration data in step 242, program control is returned to step 224 described with reference to FIG. 2A.

FIG. 2C is a flow chart illustrating a method for securely changing configuration data during run-time by executing an application program that interfaces with a BIOS run-time code, according to an embodiment. In the depicted embodiment, the application program interacts with a BIOS run-time code 290 described with reference to step 226 of FIG. 2A to change the configuration data. The application program and the BIOS run-time code 290 operate asynchronously in an interactive manner. In a particular embodiment, the application program is substantially the same as the application program 170 described with reference to FIG. 1 and is executed in a run-time mode by the OS 121 of the IHS 100. In step 252, a password to authenticate a privilege or an authority to change the configuration data is received by the application program. In an embodiment, the password may use encryption/decryption technology for improved security. In a particular embodiment, the password is indicative of receiving an authentication request to verify authority to make a change to the configuration data. The password may be received from another application program, a requester, a user and/or an administrator desiring to make a secured change in the configuration data stored in the NVM and the CMOS. In an embodiment, the application program providing the password may be executed at a remote location on another IHS that is substantially similar to and coupled to the IHS 100 via the communications device 145. That is, the authentication request to manipulate the configuration data may be provided by an administrator based at a remote location.

In step 254, a run-time interface initiation command is invoked by the application program to communicate data and/or commands to the BIOS run-time code 190. That is, the application program activates a run-time interface between the application program and the BIOS run time code 190 by executing predefined instructions and/or commands. For example, execution of the instructions may generate a software interrupt to transfer information such as commands and data between the application program and the BIOS run time code 190. The software interrupt is generated in response to writing port trapping code, where the port trapping code includes writing predefined data to a predefined data port and a predefined command to a command port. In a particular embodiment, the invoking of the run-time interface initiation command causes the IHS 100 to exit the run-time mode and operate in a systems management mode (SMM).

In step 256, the BIOS run-time code 290 receives the data and/or commands sent by the application program such as the password via an interface handler such as an interrupt initiated handling interface. In a particular embodiment, a systems management interrupt (SMI) handler of the BIOS 180 operating in the SMM mode accesses the predefined data and commands to perform requested functions. Examples of predefined commands may include an authenticate command, a GET command and a SAVE command.

Operating in the SMM mode, the BIOS run-time code 290 receives the password data as the predefined data and commands. The BIOS determines the authenticity and the authority level of the user to implement changes to the configuration data based on the password provided by the application program. In an embodiment, the determination may be performed by comparing the password with a predefined password to determine a match, with the user being authenticated in response to a perfect match. The BIOS run-time code 290 provides a security access key to application program (and hence the requester) with the occurrence of a match, e.g., indicating proper authentication and authority level verification. The security access key is used to securely change the configuration data stored in the NVM. Program control is thus transferred from the BIOS run-time code 290 back to the application program.

In step 258, the application program requests configuration data from the BIOS run-time code 290 by activating the run-time interface between the application program and the BIOS run time code 190. The application code may execute predefined instructions and/or commands such as a GET command to request the configuration data. In step 262, the run-time interface invokes the interface handler of the BIOS run time code 190 to process the request. In response, the BIOS run time code 190 sends the configuration data to the application program. Program control is thus transferred from the BIOS run-time code 290 back to the application program. Thus, the application program receives configuration data stored in the NVM from the BIOS run time code 190 in step 258. In step 264, the application program makes one or more changes to the configuration data as desired to generate a revised configuration data. In step 266, the revised configuration data and the security access key is provided to the BIOS to save the change. That is, the revised configuration data is sent to the BIOS run time code 190 via the run-time interface command mechanism described earlier to make a persistent change in the NVM.

In step 268, the BIOS run time code 190 saves the one or more changes to the configuration data after authenticating the security access key. If the security access key is authenticated the revised configuration data is stored in the NVM and the CMOS. After saving the revised configuration data program control is transferred from the BIOS run-time code 290 back to the application program. Thus changes to the configuration data are advantageously saved while the IHS 100 is operating in a run-time mode.

With reference to FIGS. 2A, 2B, and 2C various steps described above may be added, omitted, combined, altered, or performed in different orders. For example, in a particular embodiment, with reference to FIG. 2C, steps 252, 254 and 256 may include additional steps to encrypt/decrypt the password and/or security access key. As an additional example, step 268 may be omitted if the user elects not to save any changes to the configuration data.

Although illustrative embodiments have been shown and described, a wide range of modification, change and substitution is contemplated in the foregoing disclosure and in some instances, some features of the embodiments may be employed without a corresponding use of other features. Those of ordinary skill in the art will appreciate that the hardware and methods illustrated herein may vary depending on the implementation. Accordingly, it is appropriate that the appended claims be construed broadly and in a manner consistent with the scope of the embodiments disclosed herein.

What is claimed is:

1. A method for changing configuration data stored in a non-volatile memory (NVM) device of an information handling system (IHS), the method comprising:
receiving a password to authenticate a privilege to change the configuration data;
providing the password to a basic input output system (BIOS) stored in the NVM device during a run-time mode of the IHS;
receiving a security access key from the BIOS, wherein the BIOS provides the security access key in response to authenticating the password;
receiving the configuration data stored in the NVM device;
changing the configuration data to provide a revised configuration data; and
providing the security access key and the revised configuration data to the BIOS to save the change.

2. The method of claim 1, wherein the BIOS saves the change by:
authenticating the security access key;
storing the revised configuration data in the NVM device if the security access key is authenticated; and
storing the revised configuration data in a CMOS device if the security access key is authenticated.

3. The method of claim 1, wherein the password is received from a requester, wherein the BIOS returns the security access key to the requestor in response to authenticating the password.

4. The method of claim 1, wherein authenticating the password includes:
comparing the password with a predefined password to determine a match, wherein the password and hence the privilege to change the configuration data is authenticated in response to the match.

5. The method of claim 1, wherein the password is provided to the BIOS by invoking a run-time interface command, wherein invoking the run-time interface command causes the IHS to exit the run-time mode and operate in a systems management mode (SMM).

6. The method of claim 5, wherein the run-time interface command is invoked in response to writing port trapping code, wherein the port trapping code includes writing predefined data to a predefined data port and a predefined command port.

7. The method of claim 6, wherein a systems management interrupt (SMI) handler of the BIOS operating in the SMM mode accesses the predefined data.

8. The method of claim 6, wherein the predefined data includes the request to change the configuration data.

9. The method of claim 1, wherein the password is received from a software program executing on another information handling system (AIHS), wherein the IHS and AIHS are coupled by a communications link, wherein the communications link is established during the run-time mode of the IHS and the AIHS.

10. An information handling system (IHS) comprising:
a processor;
a memory coupled to the processor;
a non-volatile memory (NVM) coupled to the processor;
a basic input output system (BIOS) and configuration data stored in the NVM; and
an application program stored in the memory, wherein the application program includes instructions executable by the processor for:
receiving a password to authenticate a privilege to change the configuration data;
providing the password to the BIOS during a run-time mode of the IHS;
receiving a security access key from the BIOS, wherein the BIOS provides the security access key in response to authenticating the password;
receiving the configuration data stored in the NVM;
changing the configuration data to provide a revised configuration data; and
providing the security access key and the revised configuration data to the BIOS to save the change.

11. The system of claim 10, wherein the BIOS saves the change by:
authenticating the security access key;
storing the revised configuration data in the NVM device if the security access key is authenticated; and
storing the revised configuration data in a CMOS device if the security access key is authenticated.

12. The system of claim 10, wherein the password is received from a requestor, wherein the BIOS returns the security access key to the requestor in response to authenticating the password.

13. The system of claim 10, wherein authenticating the password includes:
comparing the password with a predefined password to determine a match, wherein the password and hence the privilege to change the configuration data is authenticated in response to the match.

14. The system of claim 10, wherein the password is provided to the BIOS by invoking a run-time interface command, wherein invoking the run-time interface command causes the IHS to exit the run-time mode and operate in a systems management mode (SMM).

15. The system of claim 14, wherein the run-time interface command is invoked in response to writing port trapping code, wherein the port trapping code includes writing predefined data to a predefined data port and a predefined command port.

16. The system of claim 14, wherein a systems management interrupt (SMI) handler of the BIOS operating in the SMM mode accesses the predefined data.

17. The system of claim 1, wherein the password is received from a software program executing on another information handling system (AIHS), wherein the IHS and AIHS are coupled by a communications link, wherein the communications link is established during the run-time mode of the IHS and the AIHS.

18. A method for changing configuration data stored in a non-volatile memory (NVM) device of an information handling system (IHS), the method comprising:
executing a basic input output system (BIOS) to change the configuration data in response to determining a mode of operation of the IHS is startup; and
executing an application program to change the configuration data in response to determining the mode of operation of the IHS is run-time.

19. The method of claim 18, wherein the application program includes instructions for:
providing a password to authenticate a privilege to change the configuration data;
receiving a security access key from the BIOS, wherein the BIOS provides the security access key in response to authenticating the password;
receiving the configuration data stored in the NVM device;
changing the configuration data to provide a revised configuration data; and
providing the security access key and the revised configuration data to the BIOS to save the change.

20. The method of claim 19, wherein the BIOS saves the change by:
authenticating the security access key;
storing the revised configuration data in the NVM device if the security access key is authenticated; and
storing the revised configuration data in a CMOS device if the security access key is authenticated.
